(19) United States
(12) Patent Application Publication
(10) Pub. No.: US 2013/0082180 A1
(43) Pub. Date: Apr. 4, 2013

(54) Multipoint Method for Assessing a Biological Sample

(71) Applicant: Chemlmage Corporation, Pittsburgh, PA (US)

(72) Inventors: Ryan Priore, Wexford, PA (US); Shona Stewart, Pittsburgh, PA (US); Patrick J. Treado, Pittsburgh, PA (US); Matthew Nelson, Harrison City, PA (US); Alan Wilson, Wexford, PA (US)

(73) Assignee: Chemlmage Corporation, Pittsburgh, PA (US)

(21) Appl. No.: 13/626,474

(22) Filed: Sep. 25, 2012

Related U.S. Application Data
(63) Continuation-in-part of application No. 13/374,703, filed on Jan. 9, 2012.
Application No. 13/374,703 is a continuation of application No. 12/422,360, filed on Apr. 13, 2009, now Pat. No. 8,094,294.
Application No. 12/422,360 is a continuation of application No. 11/000,683, filed on Nov. 30, 2004, now Pat. No. 7,538,869.
(60) Provisional application No. 60/591,132, filed on Jul. 26, 2004.
(60) Provisional application No. 60/584,718, filed on Jun. 30, 2004.

(51) Int. Cl. G01N 21/55; G01J 3/28; G01N 21/59; G01N 21/64

(52) U.S. Cl. CPC G01N 21/55; G01N 21/64; G01J 3/28; G01N 21/59
USPC 250/339.07; 250/372; 250/459.1; 356/317; 356/445; 356/432

(57) ABSTRACT

A system and method for multipoint assessment of a biological sample, which may comprise a bodily fluid. The sample is irradiated to generate a plurality of interacted photons. These photons are assessed to evaluate a component of the sample. The component may comprise at least one of: a protein, a flavonoid, a keratinoid, a metabolite, an electrolyte, an enzyme, and combinations thereof. The component may also comprise at least one of: a chemical agent, a biological toxin, a microorganism, a bacterium, a protozoan, a virus, and combinations thereof. The evaluation may comprise determining at least one of: a disease state, a disease stage, a metabolic state, a hydration state, an inflammatory state, and combinations thereof.

### RELATED APPLICATIONS

This Application is a continuation-in-part to pending U.S. patent application Ser. No. 13/374,703, filed on Jan. 9, 2012, entitled “Multipoint Method for Identifying Hazardous Agents.” This Application is hereby incorporated by reference in its entirety.

### BACKGROUND

Cancer is significant, not only in terms of mortality and morbidity, but also in terms of the cost of treating advanced cancers and the reduced productivity and quality of life achieved by advanced cancer patients. Despite the common conception of cancers as incurable diseases, many cancers can be alleviated, slowed, or even cured if timely medical intervention can be administered. A widely recognized need exists for tools and methods for early detection of cancer.

Cancers arise by a variety of mechanisms, not all of which are well understood. Cancers, called tumors when they arise in the form of a solid mass, characteristically exhibit decontrolled growth and/or proliferation of cells. Cancer cells often exhibit other characteristic differences relative to the cell type from which they arise, including altered expression of cell surface, secreted, nuclear, and/or cytoplasmic proteins, altered antigenicity, altered lipid envelope (i.e., cell membrane) composition, altered production of nucleic acids, altered morphology, and other differences. Typically, cancers are diagnosed either by observation of tumor formation or by observation of one or more of these characteristic differences. Because cancers arise from cells of normal tissues, cancer cells usually initially closely resemble the cells of the original normal tissue, often making detection of cancer cells difficult until the cancer has progressed to a stage at which the differences between cancer cells and the corresponding original normal cells are more pronounced. Depending on the type of cancer, the cancer can have advanced to a relatively difficult-to-treat stage before it is easily detectable.

Early definitive detection and classification of cancer is often crucial to successful treatment. Diagnosis of cancer must precede cancer treatment. Included in the diagnosis of many cancers is determination of the type and grade of the cancer and the stage of its progression. This information can inform treatment selection, allowing use of milder treatments (i.e., having fewer undesirable side effects) for relatively early-stage, non- or slowly-spreading cancers and more aggressive treatment (i.e., having more undesirable side effects and/or a lower therapeutic index) of cancers that pose a greater risk to the patient's health.

When cancer is suspected, a physician will often have the tumor or a section of tissue having one or more abnormal characteristics removed or biopsied and sent for histopathological analyses. Typically, the time taken to prepare the specimen is on the order of one day or more. Communication of results from the pathologist to the physician and to the patient can further slow the diagnosis of the cancer and the onset of any indicated treatment. Patient anxiety can soar during the period between sample collection and diagnosis.

A recognized need exists to shorten the time required to analyze biological sample in order so determine whether or not the sample is cancerous. Furthermore, it would be beneficial to reduce the number and/or volume of cells required for such determination, or to use bodily fluids instead of traditional tissue/cellular samples, in order to minimize patient discomfort and improve patient acceptance of testing.

Although certain immunohistology techniques can be performed without the need for microscopic visualization of cells, almost all histopathological analysis of suspected cancer cells and tissues involves microscopic examination of the suspect cells or tissue. Optical microscopy techniques are most common, owing to their relate simplicity and the wealth of information that can be obtained by visual examination of samples.

Raman spectroscopy provides information about the vibrational state of molecules. Many molecules have atomic bonds capable of existing in a number of vibrational states. Such molecules are able to absorb incident radiation that matches a transition between two of its allowed vibrational states and to subsequently emit the radiation. Most often, absorbed radiation is re-radiated at the same wavelength, a process designated Rayleigh or elastic scattering. In some instances, the re-radiated radiation can contain slightly more or slightly less energy than the absorbed radiation (depending on the allowable vibrational states and the initial and final vibrational states of the molecule). The result of the energy difference between the incident and re-radiated radiation is manifested as a shift in the wavelength between the incident and re-radiated radiation, and the degree of difference is designated the Raman shift (RS), measured in units of wavenumber (inverse length). If the incident light is substantially monochromatic (single wavelength) as it is when using a laser source, the scattered light which differs in wavelength can be more easily distinguished from the Rayleigh scattered light.

Because Raman spectroscopy is based on irradiation of a sample and detection of scattered radiation, it can be employed non-invasively and non-destructively, such that it is suitable for analysis of biological samples. Thus, little or no sample preparation is required. In addition, water exhibits very little Raman scattering, and Raman spectroscopy techniques can be readily performed in aqueous environments.

The Raman spectrum of a material can reveal the molecular composition of the material, including the specific functional groups present in organic and inorganic molecules. Raman spectroscopy is useful for detection of biological materials because most, if not all, of these agents exhibit characteristic ‘fingerprint’ Raman spectra, subject to various selection rules, by which the agent can be identified. Raman peak position, peak shape, and adherence to selection rules can be used to determine molecular identity and to determine conformational information (e.g., crystalline phase, degree of order, strain, grain size) for solid materials.

In the past several years, a number of key technologies have been introduced into wide use that have enabled scientists to largely overcome the problems inherent to Raman spectroscopy. These technologies include high efficiency solid-state lasers, efficient laser rejection filters, and silicon (Si) CCD detectors. In general, the wavelength of light used to illuminate the sample is not critical, so long as the other optical elements of the system operate in the same spectral range as the light source.

In order to detect Raman scattered light and to accurately determine the Raman shift of that light, the sample should be irradiated with substantially monochromatic light, such as light having a bandwidth not greater than about 1.3 nanometers, and preferably not greater than 1.0, 0.50, or 0.25 nanometer. Suitable sources include various lasers and polychromatic light source-monochromator combinations. It is recognized that the bandwidth of the irradiating light, the resolution of the wavelength resolving element(s), and the spectral range of the detector determine how well a spectral feature can be observed, detected, or distinguished from other spectral features. The combined properties of these elements (i.e., the light source, the filter, grating, or other mechanism used to distinguish Raman scattered light by wavelength) define the spectral resolution of the Raman signal detection system. The known relationships of these elements enable the skilled artisan to select appropriate components in readily calculable ways. Limitations in spectral resolution of the system (e.g., limitations relating to the bandwidth of irradiating light) can limit the ability to resolve, detect, or distinguish spectral features. The skilled artisan understands that and how the separation and shape of Raman scattering signals can determine the acceptable limits of spectral resolution for the system for any of the Raman spectral features described herein.

Raman spectroscopic analysis of samples can be performed to identify the chemical composition of each of the components, but such analysis can be slow, particularly where large or numerous samples are to be screened. In situations in which rapid assessment of components in a sample, or when numerous samples need to be analyzed, the capacity of traditional Raman spectroscopic techniques analytical methods can be overwhelmed, requiring bulky and expensive amounts of equipment to complete the analysis in a timely manner. There exists a need for a rapid method for assessment that can be used to analyze different components in a sample.

### SUMMARY

The present disclosure provides for a system and multipoint method of assessing a component in a biological sample. The method may comprise irradiating a biological sample, or multiple biological samples, to generate a plurality of interacted photons. The present disclosure contemplates that interacted photons could be assessed from any number of points of the sample, including three, six, ten, fifty, or any other number. The multiple points may have a defined geometric relationship or a random arrangement. Alternatively, a spectroscopic property of the sample (e.g., absorbance or reflectance of light, fluorescence, dispersive Raman spectrum, or a visible optical feature, such as the size or shape of objects in the field of view of a microscope) can be examined in order to define the relationship among points to be assessed (e.g., greater point density in areas of apparent interest). These interacted photons may be detected and assessed to evaluate a component of the sample.

Spectra generated using Raman spectroscopic methods can potentially reveal a wealth of information about molecular properties of various biological materials. Raman scattering analysis allows variations in the composition of the materials at analyzed points to be probed downed to arbitrarily small levels if desired.

The present disclosure also contemplates the use of Raman Chemical Imaging to further assess components of a sample, and provide spatial information. In many respects, Raman chemical imaging is an extension of Raman spectroscopy. Raman chemical imaging combines Raman spectroscopy and digital imaging for the molecular-specific analysis of materials. Much of the imaging performed since the development of the first Raman microprobes has involved spatial scanning of samples beneath Raman microprobes in order to construct Raman “maps” of surfaces. Historically, Raman imaging systems have been built using this so called flying spot (“point-scanning”) approach, where a laser beam is focused to a spot and is scanned over the object field, or likewise a line scanning approach, where the laser spot is broadened in one direction by, for example, a cylindrical lens, and the two dimensional image formed on a CCD array has one spatial dimension and one wavelength dimension. Raman chemical imaging techniques have only recently achieved a degree of technological maturity that allows the collection of high-resolution (spectral and spatial) data. Advancements in imaging spectrometer technology and their incorporation into microscopes that employ CCDs, holographic optics, lasers, and fiber optics have allowed Raman chemical imaging to become a practical technique for material analysis.

Raman chemical imaging is a versatile technique that is well suited to the analysis of complex heterogeneous materials, such as biological samples. In a typical Raman chemical imaging experiment, a sample is illuminated with monochromatic light, and the Raman scattered light is filtered by an imaging spectrometer which passes only a single wavelength range. The Raman scattered light may then be used to form an image of the sample. A spectrum is generated corresponding to millions of spatial locations at the sample surface by tuning an imaging spectrometer over a range of wavelengths and collecting images intermittently. Changing the selected passband (wavelength) of the imaging spectrometer to another appropriate wavelength causes a different material to become visible. A series of such images, which may be referred to as a datacube, can then uniquely identify constituent materials, and computer analysis of the image is used to produce a composite image highlighting the information desired. Although Raman chemical imaging is predominately a surface technique, depth-related information can also be obtained by using different excitation wavelengths or by capturing chemical images at incremental planes of focus. Contrast is generated in the images based on the relative amounts of Raman scatter or other optical phenomena such as luminescence that is generated by the different species located throughout the sample.

Since a spectrum is generated for each pixel location, chemometric analysis tools can be applied to the image data to extract pertinent information otherwise missed by ordinary univariate measures. A spatial resolving power of approximately 250 nm has been demonstrated for Raman chemical imaging using visible laser wavelengths. This is almost two orders of magnitude better than infrared imaging which is typically limited to 20 microns due to diffraction. In addition, image definition (based on the total number of imaging pixels) can be very high for Raman chemical imaging because of the use of high pixel density detectors (often 1 million plus detector elements

The method described herein overcomes the limitations of the prior art and holds potential for significantly increasing the speed of sample analysis. This is because the points at which interacted photons are assessed need not represent more than 25% of the area of the field of view, and can represent 5%, 1%, or less of the field.

### BRIEF DESCRIPTION OF THE DRAWINGS

FIG. 1 is illustrative of a method of the present disclosure.

FIG. 2A is a schematic diagram of a system of the present disclosure.

FIG. 2B is a schematic diagram of a system of the present disclosure.

FIG. 3 compares an optical image (FIG. 3A) of a field of view for a sample with an image showing suitable sampling points areas for multipoint Raman spectral analysis (FIG. 3B), an image representing every pixel of the viewing field, such as can be used for Raman chemical imaging (FIG. 3C), and an image showing an integrated area useful for a wide-field Raman spectral analysis (FIG. 3D).

FIG. 4 consists of FIGS. 4A and 4B. FIG. 4A is a graph of the Raman spectra of three Bacillus species and dipicolinic acid. FIG. 4B is a microscopic image of Bacillus anthracis.

FIG. 5 consists of FIGS. 5A-5H and shows various possible multipoint configurations for multipoint spectral sensing.

FIG. 6 consists of FIGS. 6A-6C and is representative of the detection capabilities of Raman spectroscopy. FIG. 6A is a brightfield reflective image and FIG. 6B is a Raman molecular image. FIG. C is representative of image spectra of the sample.

FIG. 7 consists of FIGS. 7A and 7B and is representative of the detection capabilities of Raman spectroscopy. FIG. 7A illustrates peaks associated with various components. FIG. 7B illustrates a spectrum with these peaks.

### DETAILED DESCRIPTION

The preset disclosure provides for a system and method for multipoint assessment of a biological sample. In one embodiment, the biological sample may comprise a bodily fluid such as urine, saliva, sputum, feces, blood, serum, mucus, pus, semen, fluid expressed from a wound, vaginal fluid, and combinations thereof. Examples of biological materials that can be analyzed using the system and method disclosed herein may include whole cells (e.g., normal, cancerous, or other diseased cells), extracellular matrix materials (e.g., collagens, atherosclerotic and other plaques, calcifications, bone matrix, materials of exogenous origin such as plastic or metal fragments), normal cellular components (e.g., glucose, dissolved oxygen, dissolved carbon dioxide, urea, lactic acid, creatine, bicarbonate, electrolytes, proteins, nucleic acids, cholesterol, triglycerides, and hemoglobin), serum, tissues, organs, and other biological materials.

To perform multipoint analysis, the sample and field to be evaluated is illuminated in whole or in part, depending on the nature of the sample and the type of multipoint sampling desired. A field of illumination can be divided into multiple adjacent, non-adjacent, or overlapping points, and Raman scattering analysis can be assessed at each of the points. By way of example, the entire sample can be illuminated and multipoint analysis performed by assessing Raman scattered radiation at selected points. Alternatively, multiple points of the sample can be illuminated, and Raman scattered radiation emanating from those points can be assessed. The points can be assessed serially (i.e., sequentially). To implement this strategy, there is an inherent trade off between acquisition time and the spatial resolution of the spectroscopic map. Each full spectrum takes a certain time to collect. The more spectra collected per unit area of a sample, the higher the apparent resolution of the spectroscopic map, but the longer the data acquisition takes. Performing single point measurements on a grid over a field of view can introduce sampling errors which makes a high definition image difficult to construct. Instead of serial analysis of sample points, Raman scattering can be assessed in parallel (i.e., simultaneously) for all selected points in an image field. This parallel processing of all points is designated Raman chemical imaging (RCI), and can require significant data acquisition time, computing time and capacity when very large numbers of spatial points and spectral channels are selected, but require less data acquisition time, computing time and capacity when relatively small number of spectral channels are assessed. Specifically, data acquisition time for RCI using tunable filter technology, a widely used configuration, requires more time as the number of spectral channels increases.

An important aspect of the invention is that Raman spectra are assessed at multiple points in a viewing field (e.g., the field of magnification for a microscope) that together represent only a portion of the area of the viewing field. It has been discovered that sampling the viewing field at points representing a minority of the total area of the field (e.g., at two, three, four, six, ten, fifty, one hundred, or more) points representing, in sum, 25%, 5%, 1%, or less of the field). The points can be single pixels of an image of the viewing field or areas of the field represented in an image by multiple adjacent or grouped pixels. The shape of areas or pixels assessed as individual points is not critical. For example, circular, annular, square, or rectangular areas or pixels can be assessed as individual points.

The area corresponding to each point of a multipoint analysis can be selected or generated in a variety of known ways. By way of example, a confocal mask or diffracting optical element placed in the illumination or collection optical path can limit illumination or collection to certain portions of the sample having a defined geometric relationship.

In addition to Raman spectra, other spectroscopic measurements (e.g., absorbance, fluorescence, and/or refraction) can be performed to assess one or more of the points sampled by Raman spectroscopy. This information can be used alone or as a supplement to the Raman spectral information to further characterize the portions of the sample corresponding to the individually analyzed points. This information can also be used in place of Raman spectral information. Raman spectroscopy often provides more information regarding the identity of imaged materials than many other forms of spectroscopic analysis. Additional spectroscopic information (including absorbance spectral information or image-based optical information such as the shapes of objects in the field of view) can help select a field of interest for Raman analysis, confirm the Raman spectroscopic analysis for a point, or both.

Spectroscopic analysis of multiple points in a field of view (multipoint analysis) allows high quality spectral sensing and analysis without the need to perform spectral imaging at every picture element (pixel) of an image. Optical imaging can be performed on the sample (e.g., simultaneously or separately) and the optical image can be combined with selected Raman spectrum information to define and locate regions of interest. Rapidly obtaining spectra from sufficient different locations of this region of interest at one time allows highly efficient and accurate spectral analysis and the identification of components in samples. Furthermore, identification of a region of interest in a sample or in a viewing field can be used as a signal that more detailed Raman scattering (or other) analysis of that portion of the sample or viewing field should be performed.

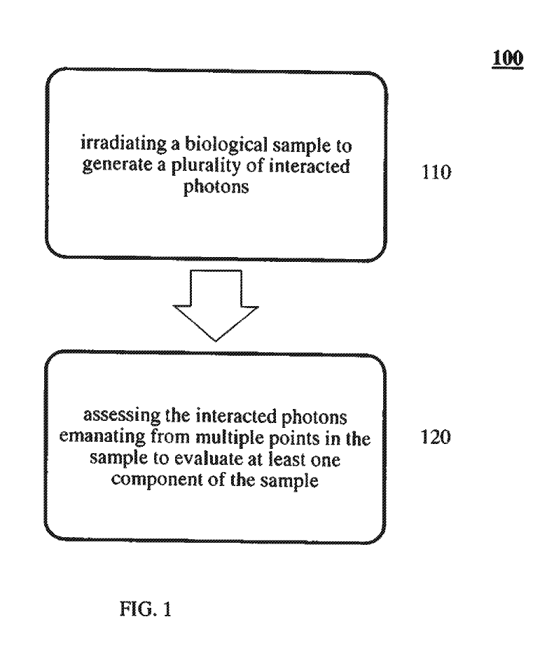

One embodiment of a method of the present disclosure is illustrated in FIG. 1A. The method 100 may comprise irradiating the sample to generate a plurality of interacted photons in step 110. Interacted photons may be collected using a variety of different devices including macroscopes, microscopes, endoscopes, telescopes, and fiber optic arrays. The interacted photons may be passed through a spectrometer, a filter, or an interferometer through which the interacted photons are passed and then detected to generate a spectroscopic data set representative of the sample. These interacted photons may be assessed in step 120 to evaluate at least one component of the sample. In one embodiment, the method 100 may further comprise selecting at least one region of interest of the sample based on the evaluation, and assessing a plurality of interacted photons from at least one other set of multiple points in the region to evaluate at least one component of the sample.

In one embodiment, the component may comprise: a chemical agent, a biological toxin, a microorganism, a bacterium, a protozoan, a virus, and combinations thereof. In another embodiment, the component may comprise at least one of: a protein, a flavonoid, a keratinoid, a metabolite, an enzyme, an electrolyte, and combinations thereof.

In one embodiment, the component may comprise a pathogenic microorganism. The pathogenic microorganism may comprise at least one of: protozoa, cryptosporidia microorganisms, Escherichia coli, Escherichia coli 157 microorganisms, Plague (Yersinia pestis), Smallpox (variola major), Tularemia (Francisella tularensis), Brucellosis (Brucella species), Clostridium perfringens, Salmonella, Shigella, Glanders (Burkholderia mallei), Melioidosis (Burkholderia pseudomallei), Psittacosis (Chlamydia psittaci), Q fever (Coxiella burnetil), Typhus fever (Rickettsia prowazekii), Vibrio cholerae, and combinations thereof.

In another embodiment, the component may comprise a bacteria comprising at least one of: Giardia, Candida albicans, Enterococcus faecalis, Staphylococcus epidermidis, Enterobacter aerogenes, Corynebacterium diphtheriae, Pseudomonas aeruginosa, Acinetobacter calcoaceticus, Klebsiella pneumoniae, and Serratia marcescens, and combinations thereof. In another embodiment, the component may comprise a fungus comprising at least one of: Microsporum audouini, Microspotum canis, Microsporum gypseum, Trichophyton mentagrophytes var. mentagrophytes, Trichophyton mentagrophytes var. interdigitale, Trichophyton rubrum, Trichophyton tonsurans, Trichophyton verrucosum, and Epidermophytum floccosum, and combinations thereof.

In yet another embodiment, the component may comprise at least one of: influenza A, influenza B, Epstein Barr virus. Group A streptococcus, Group B streptococcus, Staphylococcus aureus, methicillin-resistant Staphylococcus aureus, and combinations thereof.

In one embodiment, assessing the interacted photons may further comprise generating at least one spectroscopic data set representive of the sample. In one embodiment, the spectroscopic data set may comprise a Raman spectroscopic data set. Various determinations may be made my comparing the spectroscopic data set to at least one reference spectroscopic data set. The reference data set may be associated with at least one of a known disease state, a known disease stage, a known metabolic state, a known inflammatory state, a hydration state, and combinations thereof. The comparison may be achieved my applying at least one chemometric technique. These techniques include, but are not limited to, correlation analysis, principle component analysis, multivariate curve resolution, Mahalanobis distance, Euclidian distance, band target entropy, band target energy minimization, partial least squares discriminant analysis, adaptive subspace detection, and combinations thereof.

In one embodiment, a determination may be made as to the presence or absence of a component of interest in the sample. The component of interest may be one that is characteristic of a particular disease or disease state. In another embodiment, a determination as to a disease state, a disease stage, a metabolic state, a hydration state, an inflammatory state, and combinations thereof, may be made. It is contemplated herein that the disease state may refer to a determination of cancer vs. non-cancer.

The present disclosure also contemplates that a concentration of a component in the sample or a change in a concentration may also be determined. Changes in the amount and types of enzymes in a sample and the amount of nucleic acid content may also be assessed as part of the evaluation. In one embodiment, a conformation change in the sample may be evaluated. These characteristics may be assessed using Raman spectroscopy, Raman Chemical Imaging, and combinations thereof.

In one embodiment, the method 100 may further comprise generating a microscopic image of the sample. This microscopic image may be assessed for morphologic features such as size of a nucleus and changes in the size of a nucleus.

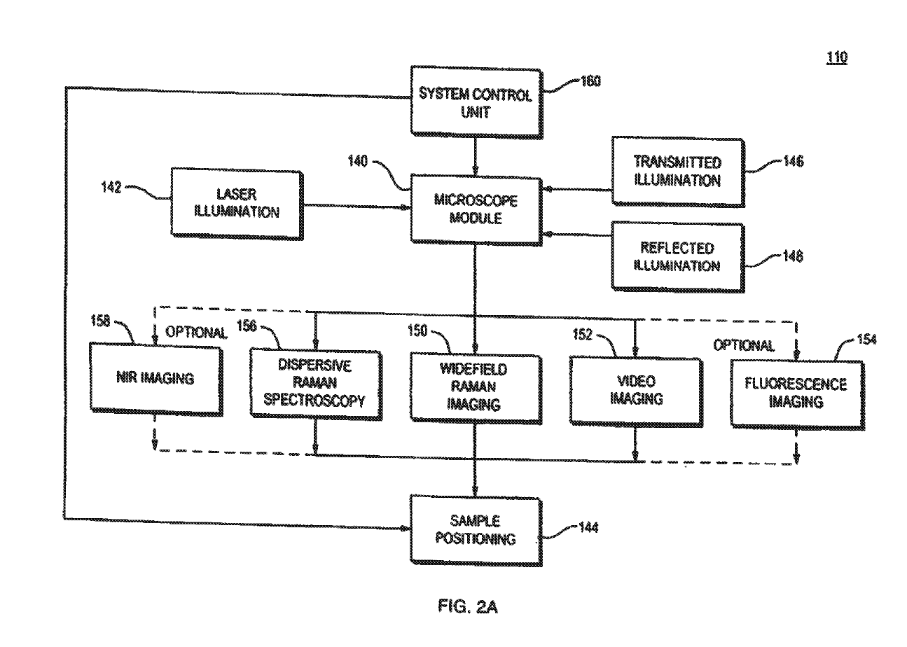

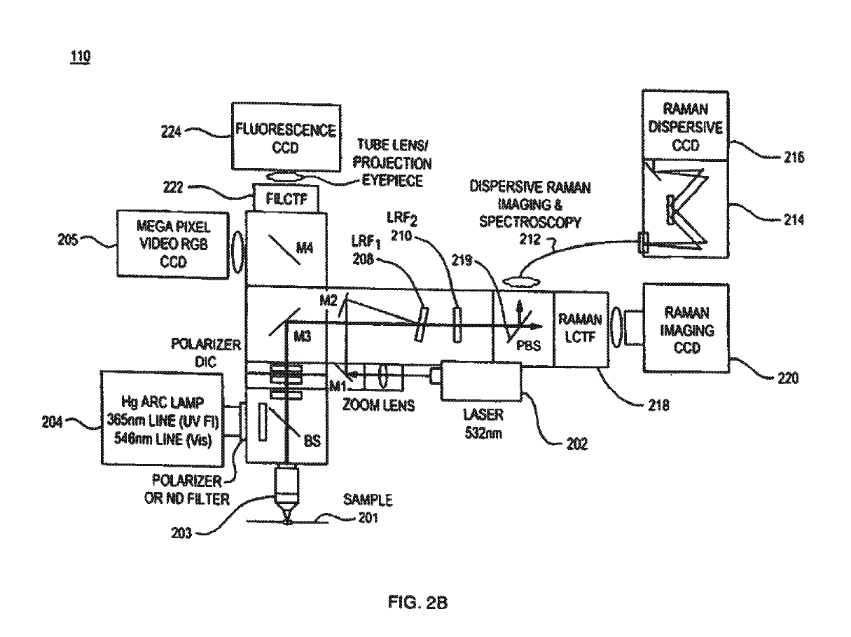

The present disclosure also provides for a system for assessing at least one component of a biological sample. One embodiment is represented in FIG. 2A. The layout in FIG. 2A may relate to the Falcon II™. Raman chemical imaging system marketed by ChemImage Corporation of Pittsburgh, Pa. In one embodiment, the spectroscopy module 110 may include a microscope module 140 containing optics for microscope applications. An illumination source 142 (e.g., a laser illumination source) may provide illuminating photons to a sample (not shown) handled by a sample positioning unit 144 via the microscope module 140. In one embodiment, photons transmitted, reflected, emitted, or scattered from the illuminated sample (not shown) may pass through the microscope module (as illustrated by exemplary blocks 146, 148 in FIG. 2A) before being directed to one or more of spectroscopy or imaging optics in the spectroscopy module 110. In the embodiment of FIG. 2A, dispersive Raman spectroscopy 156, widefield Raman imaging 150, and brightfield video imaging 152 are illustrated as “standard” operational modes of the spectroscopy module 110. Two optional imaging modes-fluorescence imaging 154 and NIR (Near Infrared) imaging 158—may also be provided if desired. The spectroscopy module 110 may also include a control unit 160 to control operational aspects (e.g., focusing, sample placement, laser beam transmission, etc.) of various system components including, for example, the microscope module 140 and the sample positioning unit 144 as illustrated in FIG. 2A. In one embodiment, operation of various components (including the control unit 160) in the spectroscopy module 110 may be fully automated or partially automated, under user control.

FIG. 2B illustrates exemplary details of the spectroscopy module 110 in FIG. 2A according to one embodiment of the present disclosure. Spectroscopy module 110 may operate in several experimental modes of operation including bright field reflectance and transmission imaging, polarized light imaging, differential interference contrast (DIC) imaging, UV induced autofluorescence imaging, NIR imaging, wide field illumination whole field Raman spectroscopy, wide field spectral fluorescence imaging, and wide field spectral Raman imaging. Module 110 may include collection optics 203, light sources 202 and 204, and a plurality of spectral information processing devices including, for example: a tunable fluorescence filter 222, a tunable Raman filter 218, a dispersive spectrometer 214, a plurality of detectors including a fluorescence detector 224, and Raman detectors 216 and 220, a fiber array spectral translator (“FAST”) device 212, filters 208 and 210, and a polarized beam splitter (PBS) 219. In one embodiment, a processor may be operatively coupled to light sources 202 and 204, and the plurality of spectral information processing devices 214, 218 and 222. In another embodiment, a processor, when suitably programmed, can configure various functional parts of the system and may also control their operation at run time. The processor, when suitably programmed, may also facilitate various remote data transfer and analysis. Module 10 may optionally include a video camera 205 for video imaging applications. Although not shown in FIG. 2B, spectroscopy module 110 may include many additional optical and electrical components to carry out various spectroscopy and imaging applications supported thereby.

Referring again to FIG. 2B, light source 202 may be used to irradiate the sample 201 with substantially monochromatic light. Light source 202 can include any conventional photon source, including, for example, a laser, an LED (light emitting diode), or other IR (infrared) or near IR (NIR) devices. The substantially monochromatic radiation reaching sample 201 illuminates the sample 201, and may produce photons scattered from different locations on or within the illuminated sample 201. A portion of the Raman scattered photons from the sample 201 may be collected by the collection optics 203 and directed to dispersive spectrometer 214 or Raman tunable filter 218 for further processing discussed later herein below. In one embodiment, light source 202 includes a laser light source producing light at 532.1 mm. The laser excitation signal is focused on the sample 201 through combined operation of reflecting mirrors M1, M2, M3, the filter 208, and the collection optics 203 as illustrated by an exemplary optical path in the embodiment of FIG. 2B. The filter 208 may be tilted at a specific angle from the vertical (e.g., at 6.5.degree.) to reflect laser illumination onto the mirror M3, but not to reflect Raman-scattered photons received from the sample 201. The other filter 210 may not be tilted (i.e., it remains at 0.degree, from the vertical): Filters 208 and 210 may function as laser line rejection filters to reject light at the wavelength of laser light source 202.

In the spectroscopy module 110 in the embodiment of FIG. 2B, the second light source 204 may be used to irradiate the sample 201 with ultraviolet light or visible light. In one embodiment, the light source 204 includes a mercury arc (Hg arc) lamp that produces ultraviolet radiation (UV) having wavelength at 365 nm form fluorescence spectroscopy applications. In yet another embodiment, the light source 204 may produce visible light at 546 nm for visible light imaging applications. A polarizer or neutral density (ND) filter with or without a beam splitter (BS) may be provided in front of the light source 204 to obtain desired illumination light intensity and polarization.

In the embodiment of FIG. 2B, the dispersive spectrometer 214 and the Raman tunable filter 218 function to produce Raman data sets of sample 201. A Raman data set corresponds to one or more of the following: a plurality of Raman spectra of the sample; and a plurality of spatially accurate wavelength resolved Raman images of the sample. In one embodiment, the plurality of Raman spectra is generated by dispersive spectral measurements of individual cells. In this embodiment, the illumination of the individual cell may cover the entire area of the cell so the dispersive Raman spectrum is an integrated measure of spectral response from all the locations within the cell.

In one embodiment, a microscope objective (including the collection optics 203) may be automatically or manually zoomed in or out to obtain proper focusing of the sample.

The entrance slit (not shown) of the spectrometer 214 may be optically coupled to the output end of the fiber array spectral translator device (FAST) 212 to disperse the Raman scattered photons received from the FAST device 212 and to generate a plurality of spatially resolved Raman spectra from the wavelength-dispersed photons. The FAST device 212 may receive Raman scattered photons from the beam splitter 219, which may split and appropriately polarize the Raman scattered photons received from the sample 201 and transmit corresponding portions to the input end of the FAST device 212 and the input end of the Raman tunable filter 218.

Referring again to FIG. 2B, the tunable fluorescence filter 222 and the tunable Raman filter 218 may be used to individually tune specific photon wavelengths of interest and to thereby generate a plurality of spatially accurate wavelength resolved spectroscopic fluorescence images and Raman images, respectively, in conjunction with corresponding detectors 224 and 220. In one embodiment, each of the fluorescence filter 222 and the Raman filter 218 includes a two-dimensional tunable filter, such as, for example, an electro-optical tunable filter, a liquid crystal tunable filter (LCTF), or an acousto-optical tunable filter (AOTF). A tunable filter may be a band-pass or narrow band filter that can sequentially pass or “tune” fluorescence emitted photons or Raman scattered photons into a plurality of predetermined wavelength bands. The plurality of predetermined wavelength bands may include specific wavelengths or ranges of wavelengths. In one embodiment, the predetermined wavelength bands may include wavelengths characteristic of the sample undergoing analysis. The wavelengths that can be passed through the fluorescence filter 222 and Raman filter 218 may range from 200 mm (ultraviolet) to 2000 nm (i.e., the far infrared). The choice of a tunable filter depends on the desired optical region and/or the nature of the sample being analyzed. Additional examples of a two-dimensional tunable filter may include a Fabry Perot angle tuned filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, and a liquid crystal Fabry Perot tunable filter. As noted before, the tunable filters 218, 222 may be selected to operate in one or more of the following spectral ranges: the ultraviolet (UV), visible, and near infrared. In one such embodiment, the tunable filters 218, 222 may be selected to operate in spectra ranges of 900-1155 cm.sup.-1 and 15-30-1850 cm.sup.-1 Raman shift values.

In one embodiment, a multi-conjugate filter (MCF) may be used instead of a simple LCTF (e.g., the LCTF 218 or 222) to provide more precise wavelength tuning of photons received from the sample 201.

In the embodiment of FIG. 2B, the fluorescence spectral data sets (output from the tunable filter 222) may be detected by the detector 224, and the Raman spectral data sets (output from the spectrometer 214 and the tunable filter 218) may be detected by detectors 216 and 220. The detectors 216, 220, and 224 may detect received photons in a spatially accurate manner. Detectors 216, 220 and 224 may include an optical signal (or photon) collection device such as, for example, an image focal plane array (FPA) detector, a charge coupled device (CCD) detector, or a CMOS (Complementary Metal Oxide Semiconductor) array sensor. Detectors 216, 220 and 224 may measure the intensity of scattered, transmitted or reflected light incident upon their sensing surfaces (not shown) at multiple discrete locations or pixels, and transfer the spectral information received to the processor module 120 for storage and analysis. The optical region employed to characterize the sample of interest governs the choice of two-dimensional array detector. For example, a two-dimensional array of silicon charge-coupled device (CCD) detection elements can be employed with visible wavelength emitted or reflected photons, or with Raman scatter photons, while gallium arsenide (GaAs) and gallium indium arsenide (GaInAs) PPA detectors can be employed for image analyses at near infrared wavelengths. The choice of such devices may also depend on the type of sample being analyzed.

In one embodiment, a display unit (not shown) may be provided to display spectral data collected by various detectors 216, 220, 224 in a predefined or user-selected format. The display unit may be a computer display screen, a display monitor, an LCD (liquid crystal display) screen, or any other type of electronic display device.

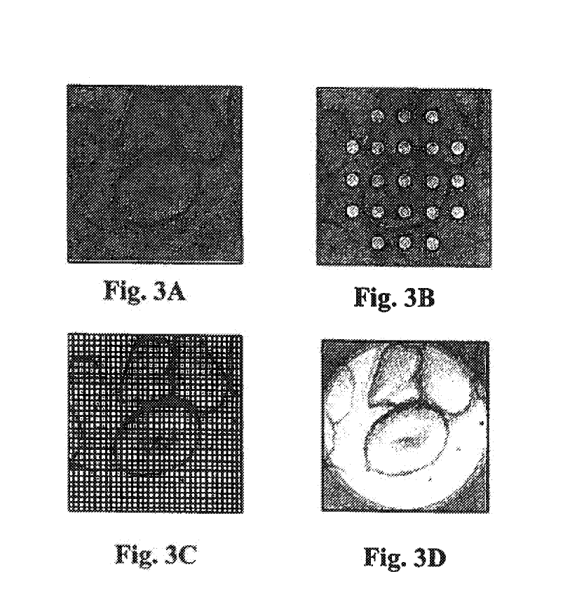

Multipoint analysis is diagrammed conceptually in FIG. 3. FIG. 3A shows an example of an area of the sample that can be optically viewed. FIG. 3B depicts a plurality of points superimposed on the field of view, indicating areas (i.e., points) at which Raman spectral information can be analyzed to estimate the identity of material(s) present in the field of view. Thus each point in a multipoint spectral analysis can have a unique spectrum associated with the object or material corresponding to the area.

In contrast, diagrams depicting how Raman spectral information is gathered in chemical imaging (FIG. 3C) or wide-field Raman spectroscopic (FIG. 3D) analyses are also shown. In chemical imaging, Raman spectral information is gathered for each pixel in the field, and the pixelated information is reconstructed to form an image. A wide-field approach requires only a single data collection (and can therefore be performed much more rapidly than chemical imaging), but averages together the spectroscopic properties of all objects in the field of view. The multipoint spectral sensing approach described herein captures the advantages of both of these methods (i.e., full chemical imaging and wide-field Raman spectroscopy) while avoiding at least some of the drawbacks of those methods.

The multipoint method can be performed much more rapidly than chemical imaging methods, because far less raw data collection is involved. By selecting multipoint areas that are on a scale corresponding to an anticipated analyte, averaging of spectral data across the relatively limited area of each point can capture the unique spectra of the analyte. Because the multipoint area can correspond to many pixels in a full chemical image, the spectral sensing points can also improve the signal-to-noise ratio of the spectrum of each area. If the non-homogeneity of a sample can be anticipated, then the area of suitable points for Raman scattering analysis can be selected or determined based on the Raman spectra of the anticipated components and their relative amounts. Point size (i.e., the size of the area sampled in each of multiple points) can thereby be selected such that Raman characteristics of the component of interest will be distinguishable from other components and anticipated background Raman scattering. The multipoint method thus can be performed with greater speed and less noise or with a greater spatial resolution and lower detection limit than the wide-field chemical imaging method.

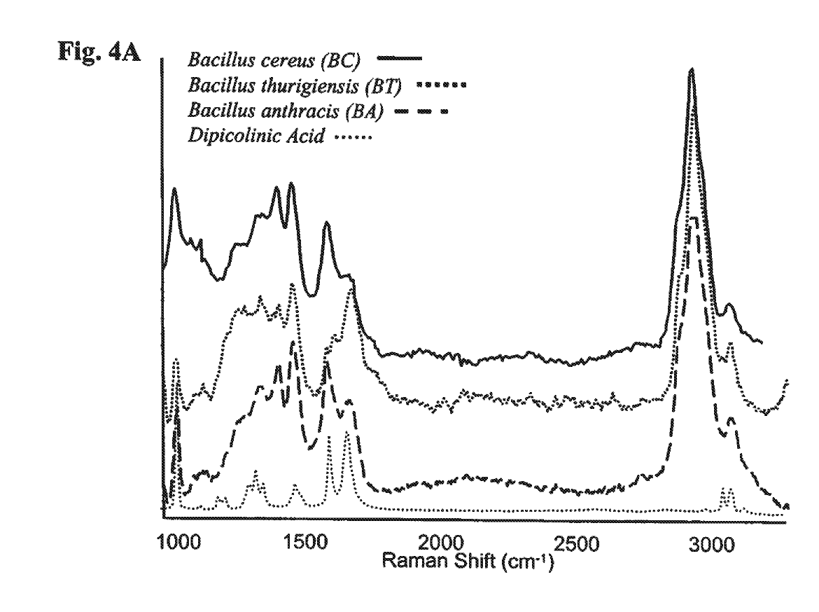

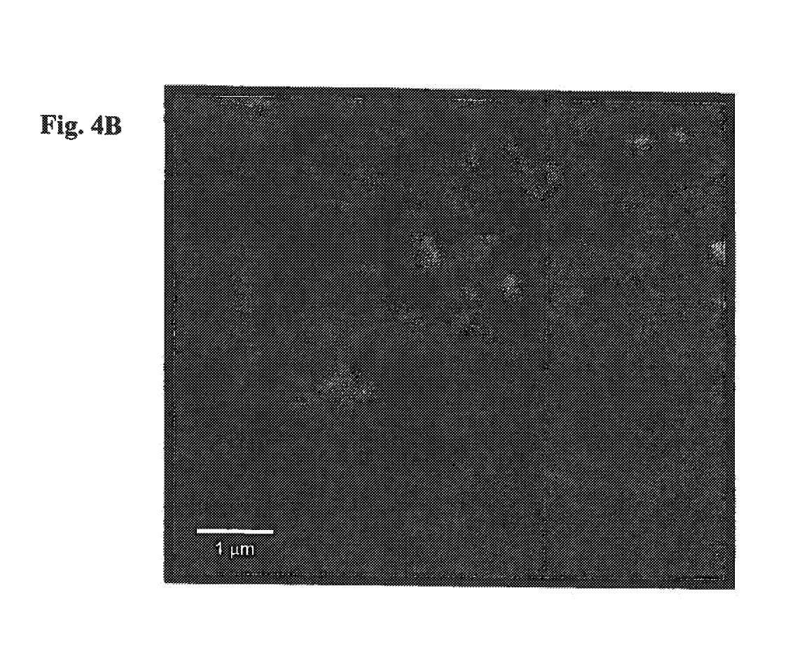

FIG. 4 shows a typical magnified view of a sample containing Bacillus anthracis. The spectra shown include a Raman spectrum corresponding to B. anthracis. The differences which are evident between the spectrum of B. anthracis and the spectra of the other Bacillus species demonstrate that B. anthracis can be differentiated from those species in a sample containing all three samples. This is performed by analyzing the Raman spectra of individual points in the sample and assigning an identity to the point, based on similarity to the known spectra. Any of a variety of known methods can be used to correlate the spectrum obtained at any particular point with reference spectra. By way of example, standard spectral library comparison methods and/or spectral unmixing methods can be used. Sampling multiple points in an image allows variations in the spectra to be observed and distinctions to be made as to components present in the various portions of the sample corresponding to the points. Acquiring data at every position and analyzing the spectra at every point in an image would require significantly greater time. Multipoint spectral sensing simplifies this by focusing on specific spatial locations within the sample.

The area of points sampled can be as small as the resolution limits of the equipment used (i.e., one pixel). Preferably, multiple pixels are included in the point, so that spectral averaging methods can be used to reduce noise in the detected signal. The size of the area of each point should preferably not be greater than a small multiple of the anticipated size of the particle size of the agent to be detected. For example, in one embodiment, if the presence or absence of bacterial spores are to be analyzed, then the point size should be not greater than 2, 3, 5, 10, or 25 times the cross-sectional area of a single spore. By way of examples, bacteria and their spores have characteristic dimensions that are typically on the order of one to several micrometers, viruses have characteristic dimensions that are on the order of tens of nanometers, and eukaryotic cells have characteristic dimensions that are on the order of ten to hundreds of micrometers. The characteristic dimensions of chemical agents, including biological toxins, depend on their agglomeration, crystallization, or other associative characteristics. The characteristic size of analytes can also depend on sample components other than the analyte itself (e.g., binding or agglomerating agents).

When the area of a sample corresponding to a point at which a Raman spectrum is assessed is much larger than a characteristic dimension of an analyte or an analyte-containing particle, the methods described herein can still be employed. In that instance, the results obtained using the method will be indicative of the presence of the analyte in a region of the sample, rather than pinpointing the location of a discrete particle of the analyte. Such regions of the sample can be subjected to further analysis (e.g., finer multipoint Raman analysis or Raman chemical imaging analysis) if desired. A skilled artisan will understand how to select appropriate point sizes based on the desired analyte in view of this disclosure.

The areas corresponding to individual points in a sample need not be equal for all points in the same field of view. For example, smaller point sizes can be used in an area of the field in which finer spatial resolution is desired. Likewise, a field of view can be analyzed separately using multiple equal point sizes. By way of example, a field of view can be first analyzed at several relatively large points and, if the analyte is recognized at one of the points, a portion of the sample corresponding to that point (e.g., the quadrant of the sample that includes the point, all areas within a certain distance of the point, or the entire sample, if desired) can be re-analyzed using smaller point sizes. Multiple rounds of such analysis and point size reduction can result in images having very finely-resolved portions of interest and more crudely-resolved areas of lesser or no interest, while minimizing information processing requirements. Variable magnification or an optical zoom can be used to vary the area of the points sampled. In this way, the area corresponding to a sampled point can be matched with the size of pixels of the detector. The area of illuminated points can be controlled in the same ways (i.e., in conjunction with a grid aperture or other beam-shaping device).

Some considerations that can affect the size and shape selected for areas corresponding to individual points include the following. The size and shape can be selected to correspond to the geometry of the device used for illuminating the sample or the geometry of detector elements in the detector. The size of the component in the sample to be detected can influence the size, shape, and spacing of the points. For instance, the area of the points can be selected so that a desired amount of the component (e.g., a single microorganism) in the point area will yield a detectable signal even if the remainder of the area is free of the component. The minimum limit of detection desired for the component can be determined by the proportion of the field of view that would be covered by the component at that level, so the pattern or number of points sampled can be selected with that component density in mind.

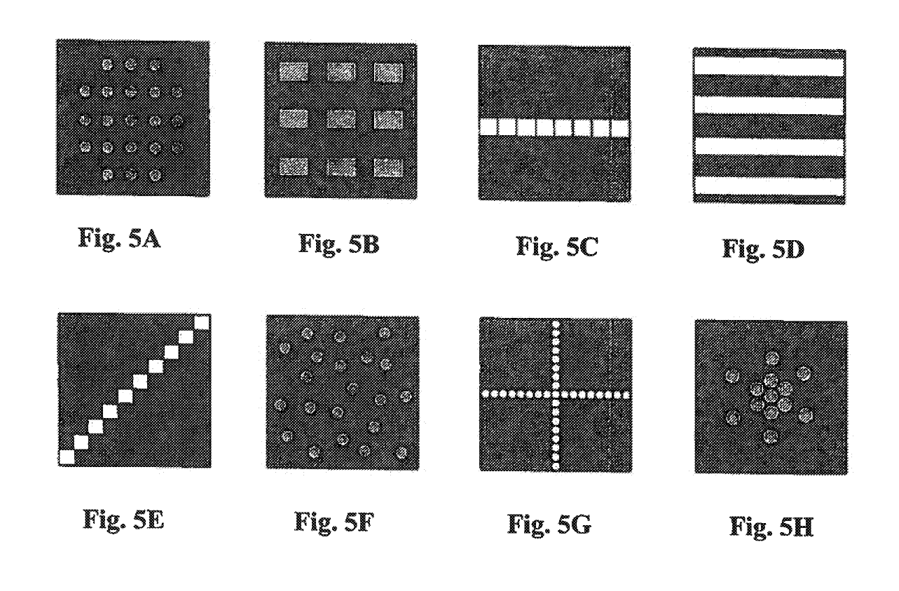

As illustrated in FIG. 5, a variety of configurations of the multiple points assayed as described herein can be used. In order to generate Raman-shifted scattered radiation at the multiple points, at least those points must be illuminated. The entire sample can optionally be illuminated. Raman scattering detector elements need be located only in positions corresponding to the selected points, although additional Raman detection scattering detector elements can be located in positions corresponding to portions of the sample that do not correspond to the points. Such additional detector elements can, for example, be employed for finer multipoint Raman analysis, for Raman chemical imaging, for alternative use with a different sample, or for some combination of these purposes. When Raman detector elements that do not correspond to the selected points are present, they can be (but need not be) masked, such as by manipulating an input transfer optics or output transfer optics of the system. Alternatively, such unused Raman detection elements can be masked by software run by a computer in the system (e.g., by simply not processing signals generated by the unused detector elements). Outputs from multiple individual Raman detection elements can be combined using known electronic and/or software methods to average the response of all detector elements corresponding to the area of a single point.

Multipoint spectral sensing can be applied separately or combined with methods of Raman, fluorescence, UV/visible absorption/reflectance, and NIR absorption/reflectance spectroscopies. Contrast can be generated in images by superimposing, adding, or otherwise combining spectral information obtained by these spectroscopic methods. Because a spectrum is generated for each point assessed in a multipoint analysis, chemometric analysis tools can be applied to the image data to extract pertinent information that might be less obvious by analyzing only ordinary univariate measures.

Furthermore, regions of a sample suitable for multipoint Raman scattering analysis can be identified by first using other optical or spectroscopic methods. By way of example, in a method for assessing the presence of a pathogenic bacterium, optical microscopy can be used to identify regions of a sample that contain entities having the size and/or shape of bacteria. Fluorescence analysis can be used to assess whether the entities identified by optical microscopy appear to be of biological origin (i.e., by exhibiting fluorescence characteristic of bacteria). For portions of the sample containing entities which appear to have the size and/or shape of bacteria and exhibit apparently biotic fluorescence, Raman scattering analysis can be performed at multiple points within that portion, as described herein. Further by way of example, near infrared (NIR) imaging can be used to identify suspicious portions of a sample, and to perform multipoint Raman scattering analysis on those suspicious portions.

By way of example, the intensity of radiation assessed at one Raman shift value can be superimposed on a black-and-white optical image of the sample using intensity of red color corresponding to intensity of the Raman-shifted radiation at a particular Raman shift value, the intensity of radiation assessed at a second Raman shift value can be superimposed on the image using intensity of blue color corresponding to intensity of the second Raman-shifted radiation, and the intensity of fluorescent radiation assessed at one fluorescent wavelength can be superimposed on the image using intensity of green color corresponding to intensity of the fluorescent radiation. Further by way of example, if the characteristics of a portion of the image are within the limits of predetermined criteria for detecting the presence of a component of interest, the portion of the image for which the characteristics meet those criteria can be made to switch on-and-off or to otherwise indicate the presence of the detected component.

Depending on the materials and the spectroscopic method(s) used, depth-related information can also be obtained by using different excitation wavelengths or by capturing spectroscopic images at incremental planes of focus.

A spatial resolving power of approximately 250 nanometers has been demonstrated for Raman spectroscopic imaging using visible laser wavelengths and commercially available devices. This is almost two orders of magnitude better than infrared imaging, which is typically limited to a resolution not better than 20 micrometers, owing to diffraction for example. Thus, multipoint size definition performed using Raman spectroscopy can be higher than other spectroscopic methods and Raman methods can be used to differentiate spectral features of small objects. Simplified designs of detectors (i.e., relative to chemical imaging devices) are possible since spectroscopic imaging and the assembly of a spectral image is not necessary in this approach.

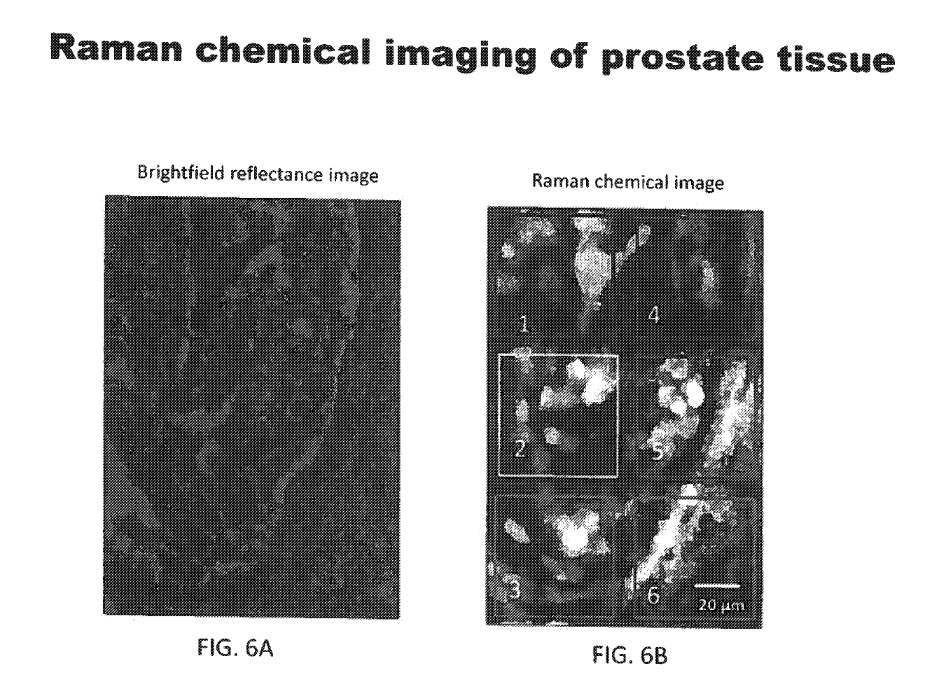

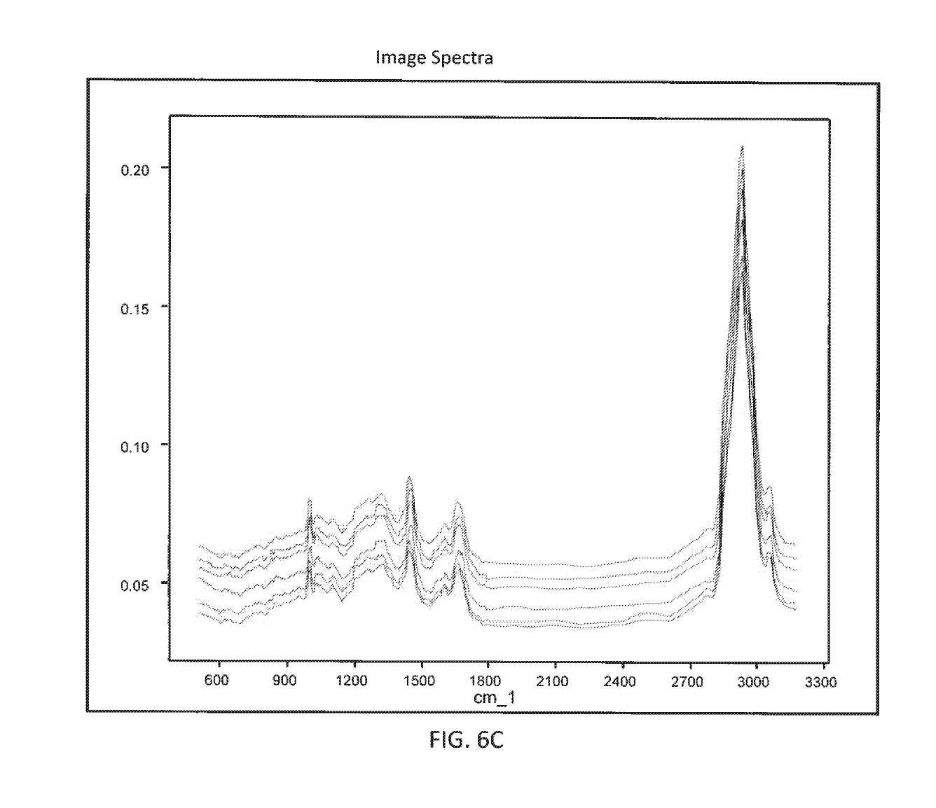

FIG. 6, consisting of FIGS. 6A-6C illustrate the detection capabilities of the present disclosure. FIG. 6A is a brightfield reflectance image of a prostate tissue sample. A Raman chemical image is represented in FIG. 6B. Multiple points in the Raman chemical image are selected for spectroscopic analysis. These spectra are represented in FIG. 6C.

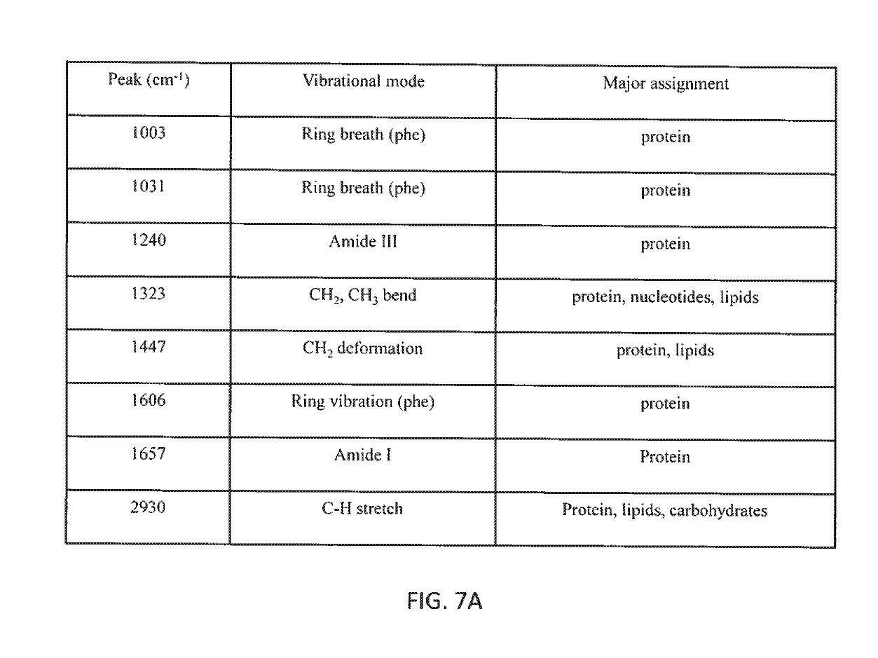

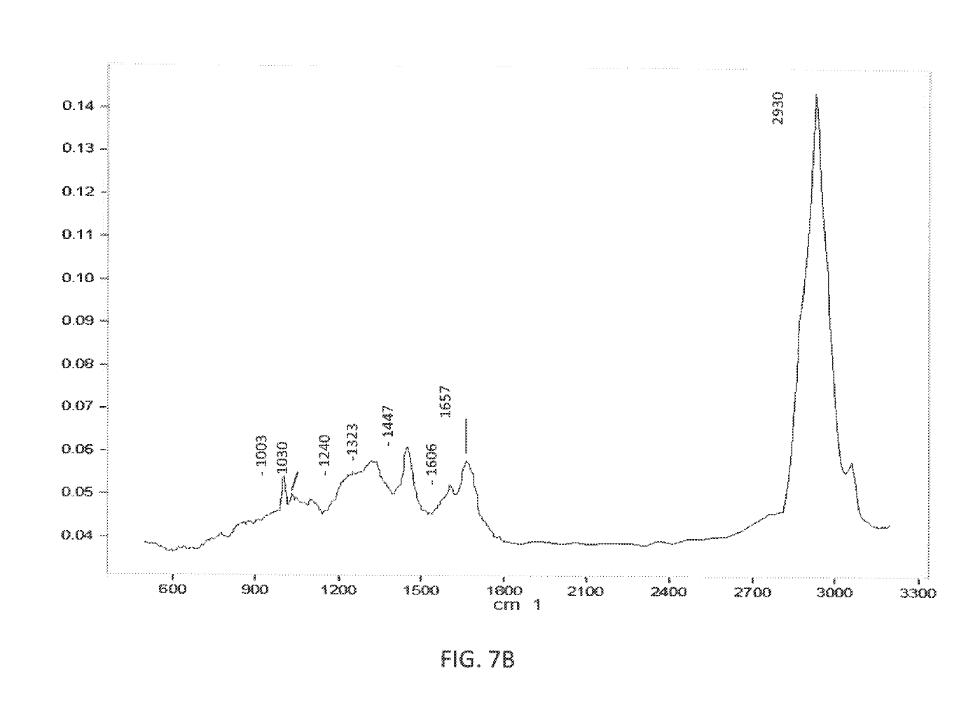

FIG. 7, consisting of FIGS. 7A and 7B illustrate the detection capabilities of the Raman spectroscopy. FIG. 7A illustrates the characteristic peak locations for various components that may be present in a biological sample. FIG. 7B illustrates these peak locations on a test spectra. The present disclosure contemplates that reference spectral peaks, as illustrated in FIG. 7A, can be used to compare to sample spectra to assess components in the sample.

The present disclosure contemplates that a variety of data processing procedures can be used for analyzing biological samples. For example, a weighted multi-point spectral data subtraction routine can be used to suppress contribution from the sample background or sample support (e.g., Raman light scattered by a microscope slide). Alternatively, multivariate spectral analysis involving principal factor analysis and subsequent factor rotation can be used for differentiation of pure molecular features in biological materials and other entities (e.g., non-threatening ‘masking’ compounds).

The following is an example of an algorithm that can be used to perform this multi-point analysis of fluorescence spectra collected for a mixture of Bacillus subtilis and B. pumilus spores as a sample:

1. Divide the raw multipoint data set (mp-data set) by a background mp-data set (taken without the sample).

2. Apply cosmic event filtering on the resultant mp-data set (median filtering for points whose value differs significantly from the mean of a local neighborhood).

3. Use an alignment procedure to correct for any slight movements of the sample during data collection.

4. Apply a spatial average filter.

5. Perform a spectral normalization (helps correct for varying illumination across the sample).

6. Perform a spectral running average over each set of three spectral values.

7. Extract a set of frames corresponding to 550 to 620 nanometers. The spectra for both bacterial spores (B. subtilis var niger and B. pumilus) can be essentially linear over this range. For example, B. subtilis var niger can have a positive slope and B. pumilus can have a negative slope.

8. Create a single frame mp-data set in which each intensity value is the slope of the spectral sub-region (from the last image). The slope is determined via a least-squares fit.

9. Scale the resulting mp-data set between 0 and 4095. Keep track of the point from 0 to 4095 that corresponds to 0 in the prior image (the “Zero point”).

10. Create a mask mp-data set image from a series of steps:

10a. From the aligned image (step 3), calculate a single frame “brightest” mp-data set in which the intensity of each point is the maximum intensity value for each spectrum.

10b. Scale this brightest mp image set between 0 and 4095.

10c. Create a binarized mp data set from the scaled mp data set, in which every point whose intensity is greater than 900 is set to 1 in the new mp data set and every point whose intensity is less than 900 is set to 0 in the new mp-data set. The value of 900 was chosen by an examination of the histogram associated with the scaled mp data set. (An improvement to this algorithm is to automatically select the threshold by numerically analyzing the histogram for a given mp data set.)

11. Multiply the scaled mp-data set from step 9 by the mask mp data set from step 10. The result is a gray scale mp data set in which intensity values below the zero value defined in step 9 correspond to B. pumilus and the intensity values above the zero point correspond to B. subtilis var niger.

The final RGB mp data set is then created by setting all the “negative” values to red and all the “positive” values to green.

While this invention has been disclosed with reference to specific embodiments, it is apparent that other embodiments and variations of this invention can be devised by others skilled in the art without departing from the true spirit and scope of the invention. The appended claims include all such embodiments and equivalent variations.

1-34. (canceled)

35. A method comprising:
irradiating a biological sample to generate a plurality of interacted photons; and
assessing the interacted photons emanating from multiple points in the sample to evaluate at least one component of the sample.

36. The method of claim 35 wherein assessing further comprises generating at least one spectroscopic data set representative of the sample.

37. The method of claim 36 wherein the spectroscopic data set further comprises a Raman spectroscopic data set.

38. The method of claim 35 wherein the biological sample further comprises a bodily fluid.

39. The method of claim 38 wherein the bodily fluid further comprises at least one of: urine, saliva, sputum, feces, blood, serum, mucus, pus, semen, fluid expressed from a wound, vaginal fluid, and combinations thereof.

40. The method of claim 35 wherein the evaluation further comprises determining at least one of: a disease state, a metabolic state, an inflammatory state, a hydration state, and combinations thereof.

41. The method of claim 40 wherein the determination is achieved by comparing at least one Raman spectrum representative of the sample with at least one reference spectrum representative of at least one of: a known disease state, a known metabolic state, a known inflammatory state, and combinations thereof.

42. The method of claim 40 wherein the comparing further comprises applying at least one chemometric technique.

43. The method of claim 42 wherein the chemometric technique further comprises at least one of: correlation analysis, principle component analysis, multivariate curve resolution, Mahalanobis distance, Euclidian distance, band target entropy, band target energy minimization, partial least squares discriminant analysis, adaptive subspace detection, and combinations thereof.

44. The method of claim 40 wherein the disease state further comprises at least one of cancer and non-cancer.

45. The method of claim 35 wherein the evaluation further comprises determining a disease stage.

46. The method of claim 35 further comprising assessing a plurality of biological samples simultaneously using a fiber array spectral translator device.

47. The method of claim 35 wherein the plurality of interacted photons are assessed simultaneously.

48. The method of claim 35 wherein the plurality of interacted photons are assessed sequentially.

49. The method of claim 35 wherein the component comprises at least one of: a chemical agent, a biological toxin, a microorganism, a bacterium, a protozoan, a virus, and combinations thereof.

50. The method of claim 35 wherein in the component comprises at least one of: a protein, a flavonoid, a keratinoid, a metabolite, an enzyme, an electrolyte, and combinations thereof.

51. The method of claim 35 wherein the evaluation further comprises determining a concentration of a component in the sample.

52. The method of claim 35 wherein the evaluation further comprises determining a change in a concentration of a component in the sample.

53. The method of claim 35 wherein the evaluation further comprises determining at least one of: the presence of a component of interest in the sample and the absence of a component of interest in the sample.

54. The method of claim 35 wherein the evaluation further comprises evaluating a conformational change in the sample.

55. The method of claim 35 wherein the evaluation further comprises assessing a change in nucleic acid content.

56. The method of claim 55 wherein the assessment is achieved using as least one of: Raman spectroscopy, Raman chemical imaging, microscopic analysis, and combinations thereof.

57. The method of claim 35 further comprising generating at least one microscopic image of the sample.

58. The method of claim 57 further comprising evaluating the microscopic image to assess change in the size of a nucleolus in the sample.

59. The method of claim 35 further comprising:
selecting at least one region of interest of the sample based on the evaluation; and
assessing a plurality of interacted photons from at least one other set of multiple points in the region to evaluate at least one component of the sample.

60. The method of claim 35 wherein the multiple points further represent a portion of total points in the field of view.

61. The method of claim 35 wherein a plurality of interacted photons from at least three points is assessed.

62. The method of claim 35 wherein a plurality of interacted photons from at least six points is assessed.

63. The method of claim 35 wherein a plurality of interacted photons from at least ten points is assessed.

64. The method of claim 35 wherein a plurality of interacted photons from at least fifty points is assessed.

65. The method of claim 35 wherein at least three of the multiple points are collinear.

66. The method of claim 35 wherein at least three of the multiple points are collinear along a first line and wherein at least three of the multiple points are collinear along a second line.

67. The method of claim 35 wherein at least four of the multiple points ate radially equidistant from a central point.

68. The method of claim 35 wherein the field of view is in a microscopic field and the sample is within the microscopic field, and the multiple points represent not more than 25% of the area of the microscopic field.

69. The method of claim 35 wherein the field of view is in a microscopic field and the sample is within the microscopic field, and the multiple points represent not more than 5% of the area of the microscopic field.

70. The method of claim 35 wherein the field of view is in a microscopic field and the sample is within the microscopic field, and the multiple points represent not more than 1% of the area of the microscopic field.

71. The method of claim 35 wherein the interacted photons are transmitted through a filter prior to evaluating the characteristic of the sample.

72. The method of claim 71 wherein the filter further comprises at least one of: of a Fabry Perot angle tuned filter, an acousto-optic tunable filter, a liquid crystal tunable filter, a multi-conjugate tunable filter, a Lyot filter, an Evans split element liquid crystal tunable filter, a Solc Liquid crystal tunable filter, a liquid crystal Fabry Perot tunable filter, and combinations thereof.

73. The method of claim 35, wherein the interacted photons are transmitted through an interferometer prior to evaluating the characteristic of the sample.

74. The method of claim 73 wherein the interferometer further comprises at least one of: a polarization-independent imaging interferometer, a Michelson interferometer, a Sagnac interferometer, a Twynam-Green interferometer, a Mach-Zehnder interferometer, a tunable Fabry Perot interferometer, and combinations thereof.

75. The method of claim 35, wherein the interacted photons are transmitted through a dispersive spectrometer prior to evaluating the characteristic of the sample.

76. The method of claim 35, wherein the interacted photons are collected using a device comprising at least one of: a telescope, a macroscope, a microscope, an endoscope, a fiber optic array, and combinations thereof.

77. The method of claim 35, wherein, at least two of the multiple points have areas that vary by at least a factor or two.

78. The method of claim 35 further comprising assessing a plurality of portions of the sample wherein the multiple points assessed in each portion have the same geometric relationship.

79. A system comprising:
an irradiation source for irradiating a biological sample to generate a plurality of interacted photons; and
a detector configured to detect the plurality of interacted photons and generate at least one spectroscopic data set representative of the sample.

80. The system of claim 79 further comprising a processor configured to assess the interacted photons emanating from multiple points in the sample to evaluate at least one component of the sample.

81. The system of claim 79 further comprising a fiber array spectral translator device.

82. The system of claim 79 further comprising a device configured to collect the plurality of interacted photons.

83. The system of claim 82 wherein the device further comprises at least one of: a telescope, a macroscope, a microscope, an endoscope, a fiber optic array, and combinations thereof.

84. The system of claim 79 further comprising a filter for filtering the plurality of interacted photons.

85. The system of claim 84 wherein the filter further comprises at least one of: of a Fabry Perot angle tuned filter, an acousto-optic tunable filter, a liquid crystal tunable filter, a multi-conjugate tunable filter, a Lyot filter, an Evans split element liquid crystal tunable filter, a Solc Liquid crystal tunable filter, a liquid crystal Fabry Perot, tunable filter, and combinations thereof.

86. The system of claim 79 wherein the detector is further configured to generate at least one Raman chemical image representative of the sample.

87. The system of claim 79 further comprising an interferometer.

88. The system of claim 87 wherein the interferometer further comprises at least one of: a polarization-independent imaging interferometer, a Michelson interferometer, a Sagnac interferometer, a Twynam-Green interferometer, a Mach-Zehnder interferometer, a tunable Fabry Perot interferometer, and combinations thereof.

89. The system of claim 79 further comprising a dispersive spectrometer.
